(19) United States
(12) Patent Application Publication
(10) Pub. No.: US 2006/0104428 A1
(43) Pub. Date: May 18, 2006

(54) Method for providing time information of called party in mobile communication terminal

(75) Inventor: Jeong-Gyu Jin, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD, Suwon-si (KR)

(21) Appl. No.: 11/265,818

(22) Filed: Nov. 3, 2005

(30) Foreign Application Priority Data
Nov. 15, 2004 (KR) 10-2004-0093085

(51) Int. Cl. H04M 15/06; H04M 1/56

(52) U.S. Cl. 379/142.01; 455/415

(57) ABSTRACT

A method for providing time information of a called party in a mobile communication terminal. The method includes receiving a phone number of the called party, detecting time difference information between an area of the mobile communication terminal and an area of the called party using the received phone number, calculating the local time of the called party according to the time difference information, and displaying the local time of the called party. The method may also include determining whether the local time for the called party is during a non-available period, such as late night or early-morning. If the local time for the called party is during a non-available period, the call may not be transmitted or may be sent to the user to re-request the sending of the call, according to different embodiments of the invention.

### PRIORITY

This application claims priority under 35 U.S.C. § 119 to an application entitled “Method for Providing Time Information of Called Party in Mobile Communication Terminal” filed in the Korean Intellectual Property Office on Nov. 15, 2004 and assigned Serial No. 2004-93085, the contents of which are incorporated herein by reference.

### BACKGROUND OF THE INVENTION

1. Field of the Invention

The present invention generally relates to a mobile communication terminal, and in particular, to a method for providing time information of a called party in a mobile communication terminal.

2. Description of the Related Art

Generally, a mobile communication terminal has a clock function to display the local time of an area where it is located. However, since the clock function of the mobile communication terminal is directed to only displaying time information of an area where a user of the mobile communication terminal is located, the user cannot intuitively know time information of another area having a time difference from the area where the user is located. To solve the problem, a mobile communication terminal has evolved to provide a global time function of storing time difference information between an area where the mobile communication terminal is located and major areas around the world and to display time information for an area selected by a user.

However, the global time function is directed to merely displaying time information for an area selected by a user by using a time difference between an area where the user is located and the selected area, and does not suggest other applications of the time difference, resulting in the low utilization of time difference information. Thus, if time difference information between major areas around the world is applied to various functions of a mobile communication terminal, such as a calling function, it is possible to improve the utilization of the time difference information and provide convenience to a user in an overseas call that requires the time difference information.

For example, when a user attempts to send a call to a person who lives in a foreign country using a mobile communication terminal, if the user is informed as to whether the called person would answer the call, it would be very helpful and convenient for the user.

### SUMMARY OF THE INVENTION

It is, therefore, an object of the present invention to provide a method for providing local time information of a called party in a mobile communication terminal, in which at a user's request for sending a call, whether to send a call is determined according to the local time of a called party.

It is another object of the present invention to provide a method for providing local time information of a called party in a mobile communication terminal, in which at a user's request for sending a call, information about whether the local time of a called party is within a call available time zone using time difference information is provided to the user to allow the user to determine whether to send a call.

To achieve the above and other objects, there is provided a method for providing time information of a called party in a mobile communication terminal. The method includes the steps of receiving a phone number of the called party, detecting time difference information between the local time at the location of the mobile communication terminal and the local time at the location of the called party using the received phone number, calculating the local time of the called party according to the time difference information, and displaying the local time of the called party.

To achieve the above and other objects, there is also provided a method for providing time information of a called party in a mobile communication terminal. The method includes the steps of receiving a phone number of the called party, detecting time difference information between the local time at the location of the mobile communication terminal and the local time at the location of the called party using the received phone number, calculating the local time of the called party according to the time difference information, determining whether the local time of the called party is within a call available time zone at a user's request for sending a call, reserving the sending of a call and determining whether the user re-requests the sending of a call if the local time of the called party is within a call non-available time zone, and sending a call if the user re-requests the sending of a call.

To achieve the above and other objects, there is also provided a method for providing time information of a called party in a mobile communication terminal. The method includes the steps of receiving information including a phone number and displaying the local time of the called party using the received information.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile communication terminal according to an embodiment of the present invention;

FIG. 2 illustrates an area-based time difference table according to an embodiment of the present invention;

FIG. 3 is a flowchart illustrating a method for providing time information of a called party in a mobile communication terminal according to a first embodiment of the present invention; and

FIG. 4 is a flowchart illustrating a method for providing time information of a called party in a mobile communication terminal according to a second embodiment of the present invention.

### DETAILED DESCRIPTION OF THE PREFERRED EMBODIMENT

Preferred embodiments of the present invention will now be described in detail with reference to the annexed drawings. In the following description, a detailed description of known functions and configurations incorporated herein has been omitted for conciseness.

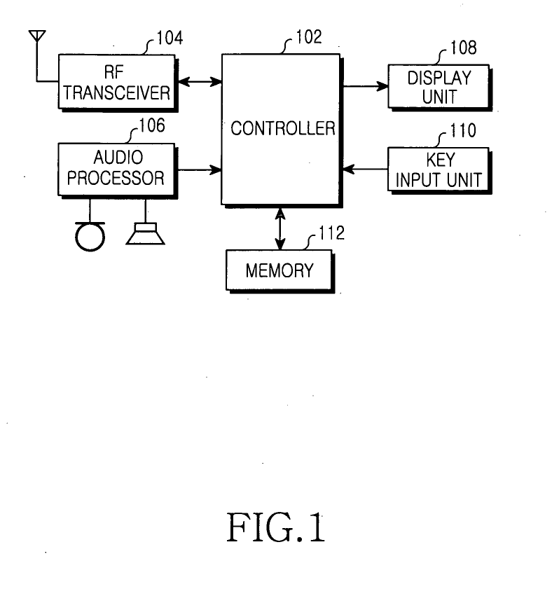

Referring now to FIG. 1, the mobile communication terminal includes a controller 102, a radio frequency (RF) transceiver 104, an audio processor 106, a display unit 108, a key input unit 110, and a memory 112.

The controller 102 controls the overall operation of the mobile communication terminal. Once a user inputs a phone number of a called party, the controller 102 calculates the local time of the called party using the input phone number and a previously stored area-based time difference table. In addition, the controller 102 controls the user's sending of a call according to the calculated local time of the called party.

The RF transceiver 104 transmits and receives audio data and control data under the control of the controller 102. Under the control of the controller 102, the audio processor 106 converts the audio data received from the RF transceiver 104 into audible sounds and outputs the audible sounds through a speaker and converts audio signals received from a microphone into data and outputs the data to the RF transceiver 104.

The display unit 108 may be a liquid crystal display (LCD) and displays a function implementing or progressing status of the mobile communication terminal and, in particular, the local time of the called party, under the control of the controller 102. In addition, the local time of the called party may be output to a user using the LCD or an output device such as a speaker.

The key input unit 110 includes a plurality of number keys and function keys and outputs key input data corresponding to a key pressed by the user to the controller 102. For example, the key input unit 110 outputs send key input data corresponding to a send key pressed by the user to the controller 102.

The memory 112 may be comprised of a Read Only Memory (ROM) and a Random Access Memory (RAM) to store a plurality of programs and data. The memory 112 stores country codes for countries corresponding to areas where a called party may be located, area codes for the areas where the called party may be located, and time difference information between the local time where a calling party is located and the local time where the called party may be located according to an embodiment of the present invention.

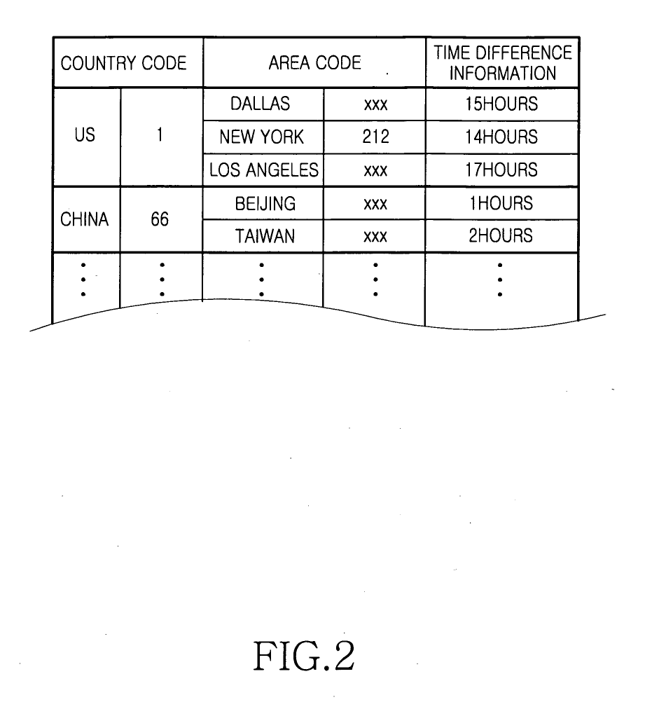

FIG. 2 illustrates an area-based time difference table which tabulates country codes for countries corresponding to areas where a called party may be located, area codes for the areas where the called party may be located, and time difference information between an area where a calling party is located and the areas where the called party may be located. For example, in the area-based time difference table, when an area of a calling party is Korea, a country code for US is stored as 1, a country code for China is stored as 66, and country codes for other countries are stored in this way. Area codes and time difference information between Korea and corresponding areas are stored for corresponding countries.

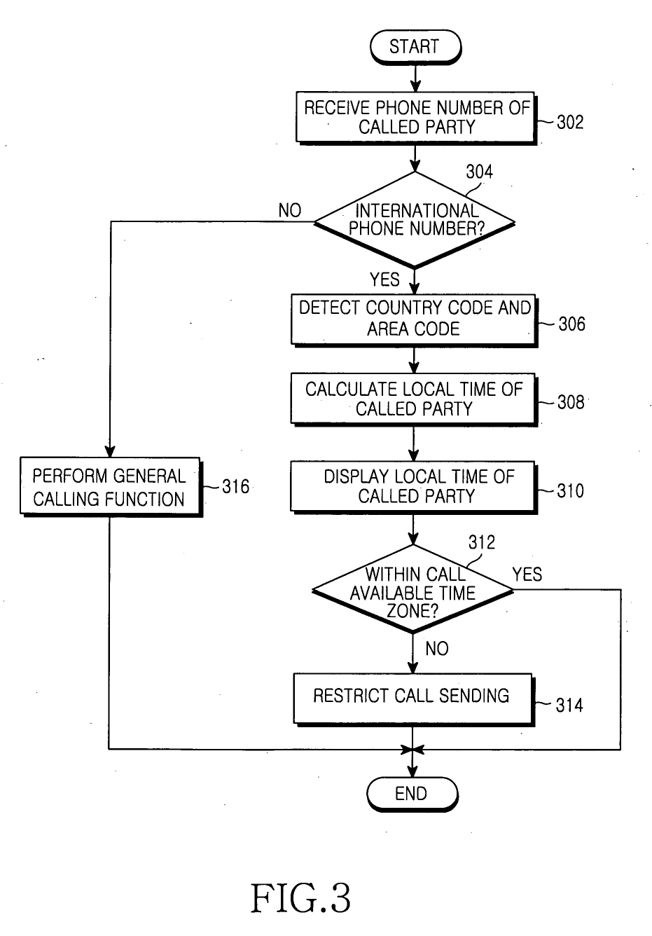

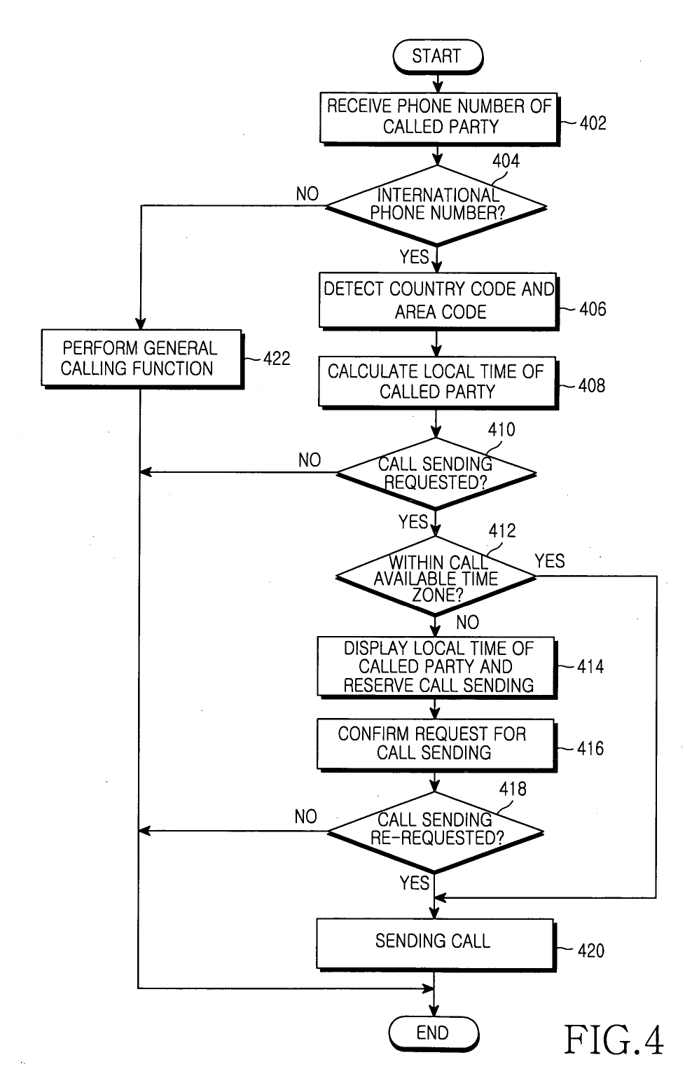

The mobile communication terminal according to an embodiment of the present invention provides time information of a called party using the stored area-based time difference table at the time of sending a call and controls the sending of a call according to the time information of the called party. The sending of a call by the mobile communication terminal is controlled according to the time information of the called party, as shown in FIGS. 3 and 4.

FIG. 3 is a flowchart illustrating a method for providing time information of a called party in a mobile communication terminal, in which a user inputs a phone number of a called party into the controller 102 in step 302. Upon input of the phone number of the called party, the controller 102 determines whether the input phone number is an international phone number in step 304. Since an international phone number is generally comprised of ‘International phone code-Country code-Area code-Phone number’, the controller 102 checks if a first part of the input phone number includes an international phone code such as ‘001’ to determine whether the input phone number is an international phone number. In other words, if the international phone code is included in the input phone number, the controller 102 determines that the input phone number is an international phone number. Otherwise, the controller 102 determines that the input phone number is not an international phone number.

If the input phone number is not an international phone number, the controller 102 proceeds to step 316 to perform a general calling function. If the input phone number is an international phone number, the controller 102 detects a country code and an area code from the input phone number in step 306.

The controller 102 calculates the local time of the called party using time difference information according to the detected country code and the detected area code in step 308. For example, referring to FIG. 2, when the local time of a calling party, i.e., the mobile communication terminal, is Sat., Nov. 5, 3:30 PM, the detected country code is ‘1’, and the detected area code is ‘212’, the controller 102 calculates the local time of the called party as Fri., Nov. 4, 1:30 AM, using time difference information ‘14 hours’ according to the local time of the calling party, the detected country code, and the detected area code.

After calculating the local time of the called party, the controller 102 displays the calculated local time of the called party in step 310. The controller 102 then determines whether the calculated local time is within a call available time zone in step 312. For example, if the calculated local time of the called party is within a time zone from 6:00 AM to 10:00 PM, since there is a high possibility that the called party is active, the controller 102 determines that the calculated local time of the called party is within the call available time zone. If the calculated local time of the called party is within a time zone from 10:00 PM to the next morning 6:00 AM, since there is a high possibility that the called party is not active, the controller 102 determines that the calculated local time of the called party is within a call non-available time zone. The call available time zone and the call non-available time zone can be set.

If the calculated local time of the called party is within the call available time zone, the controller 102 performs a general overseas calling function. If the calculated local time of the called party is within the call non-available time zone, the controller 102 controls the mobile communication terminal not to send an international call, i.e., not to send a call.

In the method for providing time information of a called party according to the first embodiment of the present invention, the sending of a call is restricted regardless of a user's intention if the time of the called party is within the call non-available time zone.

However, according to a second embodiment of the present invention, if the time of a called party is within the call non-available time zone, whether to send a call is confirmed by a user and the sending of a call is controlled according to the user's confirmation.

FIG. 4 is a flowchart illustrating a method for providing time information of a called party in a mobile communication terminal, in which a user inputs a phone number of a called party to the controller 102 in step 402. Upon input of the phone number, the controller 102 determines whether the input phone number is an international phone number in step 404. In other words, the controller 102 checks if an international phone code is included in the input phone number to determine whether the input phone number is an international phone number.

If the input phone number is not an international phone number, the controller 102 proceeds to step 422 to perform a general calling function. If the input phone number is an international phone number, the controller 102 detects a country code and an area code of the input phone number in step 406.

The controller 102 calculates the local time of the called party using time difference information according to the detected country code and the detected area code in step 408.

After calculating the local time of the called party, the controller 102 determines whether the user requests the sending of a call to the input phone number in step 410. If the user requests the sending of a call, the controller 102 determines whether the local time of the called party is within the call available time zone in step 412.

If the local time of the called party is within the call non-available time zone (from 10:00 PM to the next morning 6:00 AM) where the called party may not be active, the controller 102 displays the local time of the called party and reserves the sending of a call in step 414. The controller 102 then confirms the request for sending a call with the user in step 416 to confirm whether the user desires to send a call even though the local time of the called party is within the call non-available time zone. After confirming the request for sending a call with the user, the controller 102 determines whether the user re-requests the sending of a call in step 418. In other words, it is determined whether the user re-requests the sending of a call even though the local time of the called party is within the call non-available time zone. If the user re-requests the sending of a call, a call is sent to the input phone number of the called party in step 420. If the user does not re-request the sending of a call, the process is terminated.

As described above, according to the present invention, time information of a called party is provided to a user when the user attempts to send a call, thereby allowing the user to be aware of the time information for the called party and then to determine whether to send a call.

In addition, according to the present invention, when a user attempts to send a call to a called party who lives in a foreign country using a mobile communication terminal, if the time of the called party is within a call non-available time zone where the called party cannot normally answer the call, the sending of a call is automatically restricted, thereby extending courtesy to the called party.

While the invention has been shown and described with reference to certain preferred embodiments thereof, it will be understood by those skilled in the art that various changes in form and details may be made therein without departing from the spirit and scope of the invention.

What is claimed is:

1. A method for providing time information of a called party in a mobile communication terminal, the method comprising the steps of:
receiving a phone number of the called party;
detecting time difference information between a local time at a location the mobile communication terminal and a local time at a location of the called party using the received phone number;
calculating the local time of the called party according to the time difference information; and
displaying the local time of the called party.

2. The method of claim 1, further comprising the step of determining whether the local time of the called party is within a call available time zone and displaying the local time of the called party.

3. The method of claim 1, further comprising the step of determining whether the local time of the called party is within a call available time zone and restricting the sending of a call to the received phone number of the called party if the local time of the called party is within a call non-available time zone.

4. The method of claim 1, wherein the step of detecting time difference information comprises:
analyzing the received phone number of the called party to detect a country code and an area code of the called party; and
detecting time difference information corresponding to the detected country code and the detected area code from a previously stored area-based time difference table.

5. A method for providing time information of a called party in a mobile communication terminal, the method comprising the steps of:
receiving a phone number of the called party;
detecting time difference information between a local time at a location of the mobile communication terminal and a local time at a location of the called party using the received phone number;
calculating the local time of the called party according to the time difference information;
determining whether the local time of the called party is within a call available time zone at a user's request for sending a call;
reserving the sending of a call and determining whether the user re-requests the sending of a call if the local time of the called party is within a call non-available time zone; and
sending the call if the user re-requests the sending of the call.

6. The method of claim 5, wherein the step of detecting time difference information comprises the steps of:
analyzing the received phone number of the called party to detect a country code and an area code of the called party; and
detecting time difference information corresponding to the detected country code and the detected area code from a previously stored area-based time difference table.

7. The method of claim 5, wherein the mobile communication terminal determines that the local time of the called party is within the call non-available time zone if the local time of the called party is within a time zone from 10:00 PM to the next morning at 6:00 AM and determines that the local time of the called party is within the call available time zone if the local time of the called party is within a time zone from 6:00 AM to 10:00 PM.

8. A method for providing time information of a called party in a mobile communication terminal, the method comprising the steps of:
receiving information including a phone number; and
displaying the local time of the called party using the received information.
